(19) United States
(12) Patent Application Publication
(10) Pub. No.: US 2013/0187752 A1
(43) Pub. Date: Jul. 25, 2013

(54) Coded Doorbell Chime

(71) Applicant: Eduard Grigorian, Fresno, CA (US)

(72) Inventor: Eduard Grigorian, Fresno, CA (US)

(21) Appl. No.: 13/492,827

(22) Filed: Jun. 9, 2012

Related U.S. Application Data
(60) Provisional application No. 61/632,206, filed on Jan. 20, 2012.

(51) Int. Cl. G06F 7/04

(52) U.S. Cl. 340/5.8

(57) ABSTRACT

A coded doorbell chime and a system therefore that is useful for effectively screening visitors at an entrance into the structure by providing one or more different doorbell sounds for different visitors or categories of visitors, such as family, friends and the like. The coded doorbell chime comprises a doorbell activating device, having a housing, a doorbell switch and a keypad associated therewith, and a sound producing mechanism, having a housing, sound generator and a speaker associated therewith, operatively connected to the doorbell activating device. Selected visitors enter a code to produce a first sound identifying them as a person the occupant of the structure knows. Other visitors use the doorbell switch to produce a second sound that identifies them as a person the occupant does not know. Preferably, the doorbell switch is on the outer surface of a moveable cover that hides the keypad when the cover is closed.

### CROSS-REFERENCE TO RELATED APPLICATIONS

This patent application claims priority to U.S. Provisional Patent Application No. 61/632,206 filed Jan. 20, 2012.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to doorbells and doorbell systems that are commonly utilized to inform someone inside a house, office or other structure that there is someone at a door into the structure. More specifically, the present invention relates to such doorbell and doorbell systems that are configured to produce different chimes or other sounds based on the identity of the person who is activating the doorbell. Even more specifically, the present invention relates to such doorbells and doorbell systems that utilize an activating mechanism that can be set by the user to allow different persons to announce their presence by different chimes or other sounds so the user can know whether the visitor at the door is known or unknown unbeknownst to the visitor.

B. Background

Most homes have a door that is the primary entrance into the interior of the home, a doorbell activating device at or near the door which is operatively connected to a doorbell chime, ringer or other sound producing mechanism inside the home that is energized to inform persons inside the home that someone is at the door. Usually, but not exclusively, the doorbell activating device is a standard push button switch that is attached or otherwise mounted to an outer wall or other surface at or near the door, usually within arm's reach of the door. Likewise, the sound producing mechanism associated with a doorbell activating device is usually, but not exclusively, attached or otherwise mounted onto a wall in the interior of the home. A typical doorbell activating device and its sound producing mechanism are wired into the home to electrically connect to the home's power supply system and they are connected to each other by one or more wires. In other doorbell systems, one or both the doorbell activating device and sound producing mechanism may be powered by one or more batteries disposed in a housing that is associated with the device and/or mechanism. In other doorbell systems, the activating device and the sound producing mechanism may connect wirelessly such that activation of the doorbell activating device by a person at the door will send a wireless signal to the sound producing mechanism to generate the chime, ring, bell or other sound inside the home. Although not as common, a doorbell activating device and its associated sound producing mechanism are also utilized with offices, stores and other structures that have a door which is selectively opened to allow access to the interior of the structure (e.g., for delivery purposes, allow employees in and like circumstances).

As well known in the art, all presently available doorbell activating devices have a single switch mechanism, whether it is a push-button or other type of switch, that activates the sound producing mechanism to produce a single sound or group of sounds for each activation of the device (e.g., push of the button) by the person at the door having the doorbell activation device. In the past, there were very few options with regard to doorbells and doorbell systems in that they all generally worked about the same way and activated somewhat similar doorbell chimes. In contrast, many modern doorbell systems have various options available that allow the user thereof to select the doorbell system which provides features he or she believe are advantageous to their particular situation. One such feature is the use of a sound producing mechanism that is capable of producing a wide variety of different sounds so the user can select which sound he or she desires to have associated with the home or other structure. Some of these mechanisms are pre-programmed with two or more different sounds and a selection apparatus that allows the user to select which sound is most appealing or interesting to him or her. Other sound producing mechanisms have electronic components that are capable of producing a wide range of sounds from which the user can select his or her doorbell sound. In some configurations, the sound producing mechanism has the ability to allow the user to electronically add and store his or her own selected doorbell sound to the mechanism. Some of these latter sound producing mechanisms can add sounds that are custom made by the user or which are purchased from the Internet or other sources. Some doorbell activating devices are configured with decorative components or components that either blend into or contrast with the surface on which they are mounted.

One of the primary limitations of presently configured doorbells and doorbell systems is that the user in the home or other structure typically has no way to know who is at the door when the doorbell activates the sound producing mechanism, regardless of the sound or source of sound generated by the sound producing mechanism. Some modern doorbell systems are configured with a video camera, intercom and/or other security component that is associated with the doorbell activating device to allow the user to see and/or communicate with the person at the door without having to go to the door. Generally, these systems are very expensive and only allow the user to see and/or talk to the person at the door if he or she is willing to be seen and/or willing to talk to the person in the home or other structure. In addition, it is usually very difficult or expensive to retrofit an existing structure with a doorbell system which includes components such as a video camera, intercom or the like.

In general, the above-described limitation with regard to not knowing who is at the door can create a number of problems. Although most people who are at the door are friendly, known to the occupant of the structure and, often, anticipated by the occupant to arrive at the door, this is not always the situation. For instance, although a person may be glad to see his or her children or other family members, friends, co-workers and the like at the door, there are likely a number of people, or class of people, who the occupant does not want to have contact with at the door. For instance, many occupants of a building do not want to communicate with door-to-door salespeople, persons soliciting miscellaneous goods and/or services, political representatives and the like who happen to show up at their door. Instead of greeting these people, the occupant of the structure may prefer to ignore these and similar types of persons. There may even be times when the occupant of a structure does not want to acknowledge and/or communicate with certain (or even all) family members. Although the occupant of a structure may not desire to see or speak to certain people, there are likely to be other persons who the occupant does desire to speak to or even allow entrance into the structure through the door associated with the doorbell. Unfortunately, with regard to presently available doorbell systems, except for going to the door or a window near the door and looking out to see who is there or through the use of expensive and often limited security systems, there is presently no way for the occupant to know who or even what class (family, friend, salesperson or etc.) of person is at the door.

What is needed, therefore, is an improved doorbell and doorbell system that allows the user to selectively program the doorbell activating device so certain visitors will be able to cause the sound producing mechanism to produce a sound that is associated with a particular visitor or class of visitors which is distinct from other visitors or class of visitors, particularly visitors who operate the default doorbell sound. An improved doorbell and doorbell system should be configured with a doorbell activating device that in one manner of operation causes the sound producing mechanism to produce sound which lets the occupant of a structure know that a person at the door is not a person who is in a specially selected group of persons so the occupant can choose not to go to the door at all. The improved doorbell and doorbell system should allow the user thereof to select people or groups of people who will cause the sound producing mechanism to produce one or more sounds that are distinct from other persons. As such, the doorbell activating device should be configured to allow selective operation thereof and the sound producing mechanism should be configured to be able to selectively produce two or more different sounds depending on the selection at the doorbell activating device.

### SUMMARY OF THE INVENTION

The coded doorbell chime of the present invention solves the problems and provides the benefits identified above. That is to say, the present invention discloses an improved doorbell and doorbell system having a doorbell activating device and cooperatively configured sound producing mechanism that provide the occupant of a home, office, store or other structure with the ability to know who, or if so arranged at least what category of person, is at the door by the sound produced by the person activating the sound producing mechanism. The doorbell and doorbell system of the present invention are configured to allow the user thereof to program the doorbell activating device so that a visitor or category of visitors at a door into a structure can cause the sound producing mechanism to produce a doorbell sound inside of the structure that is different than one or more other visitors or category of visitors. In one embodiment, the doorbell activating device has a programmable keypad and a typical doorbell push-button switch, with one or more selected visitors entering a code on the keypad to cause the sound producing mechanism to produce a certain sound and other persons using the default push-button switch to cause the sound producing mechanism to produce a different sound so the occupant will know who or at least the category of person who is at the door without having to go to the door and look or utilize a security system. In a preferred configuration of the present invention, the default push-button switch is on a door-like component that swings, pivots, slides or otherwise moves out of the way to allow access to the keypad for persons who know the keypad is there and the code to enter into the keypad to cause the sound producing mechanism to produce a sound that is different than the sound produced by using the default switch. In one embodiment, if the user enters an incorrect code at the keypad the default doorbell sound will be activated. The coded doorbell chime of the present invention is relatively inexpensive to install and easy to use.

In one general aspect of the present invention, the coded doorbell chime comprises a doorbell activating device that is accessed by the visitor to a structure and a sound producing mechanism that produces a sound identifying, at least generally, the visitor. The doorbell activating device has a first housing that is structured and arranged to be attached to or mounted on an outwardly facing surface of an outer wall of a structure, a keypad on the first housing and a processor which is disposed inside the first housing. The keypad has a plurality of keys and the processor is operatively connected to the keypad to allow entry of a code into the processor using the keypad. Preferably, a cover is moveably attached to the first housing, typically either by being pivotally or slidably attached thereto. The cover is structured and arranged to hide the keypad when the doorbell activating device is in its closed position and to expose the keypad when the doorbell activating device is in its opened position. A doorbell switch is provided on an outer surface of the cover so as to be facing outwardly therefrom when the doorbell activating device is in the closed position with the cover over the keypad. Persons not knowing the code will use the doorbell switch on the outside of the cover. Those visitors knowing the code will use the keypad to enter the code. The sound producing mechanism has a second housing that is structured and arranged to be attached to or mounted on an inwardly facing surface of an inner wall of the structure, a sound generator that is disposed in the second housing and a speaker which is associated with the second housing and connected to the sound generator. The sound generator is operatively connected to the doorbell activating device, either being wired or wirelessly connected thereto, to produce a first sound through the speaker when the code is entered into the processor and a second sound through the speaker when the doorbell switch is operated.

Accordingly, the primary objective of the present invention is to provide an improved doorbell and doorbell system that provides the advantages discussed above and which overcomes the disadvantages and limitations associated with presently available doorbells and doorbell systems.

It is also an important object of the present invention to provide a new and improved doorbell and doorbell system that is configured to allow the occupant of a structure to at least generally know if the person at the door who is operating the doorbell is a person who is known to the occupant and to whom the occupant desires to meet at the door, typically to allow the person access into the interior of the structure.

It is also an important object of the present invention to provide an improved doorbell and doorbell system that is configured to produce two or more distinct sounds from a sound producing mechanism that is operatively connected to a doorbell activating device at or near a door into a structure which provides the ability for different visitors to the structure to cause different sounds to be produced from the mechanism based on the identity, at least generally, of the person at the door who is operating the doorbell activating device.

It is also an important object of the present invention to provide an improved doorbell and doorbell system which allows a person at a door into a structure to enter a code into a doorbell activating device that will cause a sound producing mechanism associated therewith to produce a sound which identifies, at least generally, the person at the door as someone who is known to the occupant so as to distinguish that person from others who are not known to the occupant or to whom the occupant does not want to speak.

It is also an important object of the present invention to provide an improved doorbell and doorbell system that comprises a doorbell activating device having a keypad which is utilized by a visitor to a structure to enter a code that produces a particular sound from a sound producing mechanism that is distinct from other sounds that are produced without entering in the code.

It is also an important object of the present invention to provide an improved doorbell and doorbell system that comprises a doorbell activating device which has a keypad which is hidden behind a door-like component that has a typical doorbell switch, with the keypad being used to enter a code to produce doorbell sounds which are distinct from the sound produced by using the typical, default switch.

Another important object of the present invention is to provide an improved doorbell and doorbell system that produces different doorbell sounds based on the identity, at least generally, of different visitors to a structure and which can be utilized with a wide variety of different types of structures, is relatively inexpensive to manufacture and easy to use.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top plan view of a structure having a coded doorbell chime that is configured according to one embodiment of the present invention shown with the roof of the structure removed to show the interior of the structure so as to better illustrate the relative position of the components of the system of the present invention;

FIG. 2 is a front view of a section of an outer surface showing a door and doorbell activating device and a front view of a section of an interior surface showing the sound producing mechanism of the coded doorbell chime of FIG. 1;

FIG. 3 is a front view of the doorbell activating device and sound producing mechanism of the coded doorbell chime of FIG. 1;

FIG. 4 is a front view of a second embodiment of the doorbell activating device of the coded doorbell chime of the present invention shown in its closed position;

FIG. 5 is a front view of the doorbell activating device of FIG. 4 shown in its open position with the outer cover thereof pivoted open to expose a keypad for entering a pre-selected code to activate a sound producing mechanism; and

FIG. 6 is a front view of a third embodiment of the doorbell activating device of the coded doorbell chime of the present invention shown in its open position with the outer cover thereof slid upward to expose a keypad for entering a pre-selected code to activate a sound producing mechanism.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and the description set forth herein are primarily directed to a coded doorbell chime and system utilized with a door that opens to an outside area to allow access to the interior of a structure, persons skilled in the art will readily understand that this is merely for purposes of simplifying the present disclosure and that the present invention is not so limited. The coded doorbell chime of the present invention can be utilized anywhere prior art doorbell systems are or can be utilized.

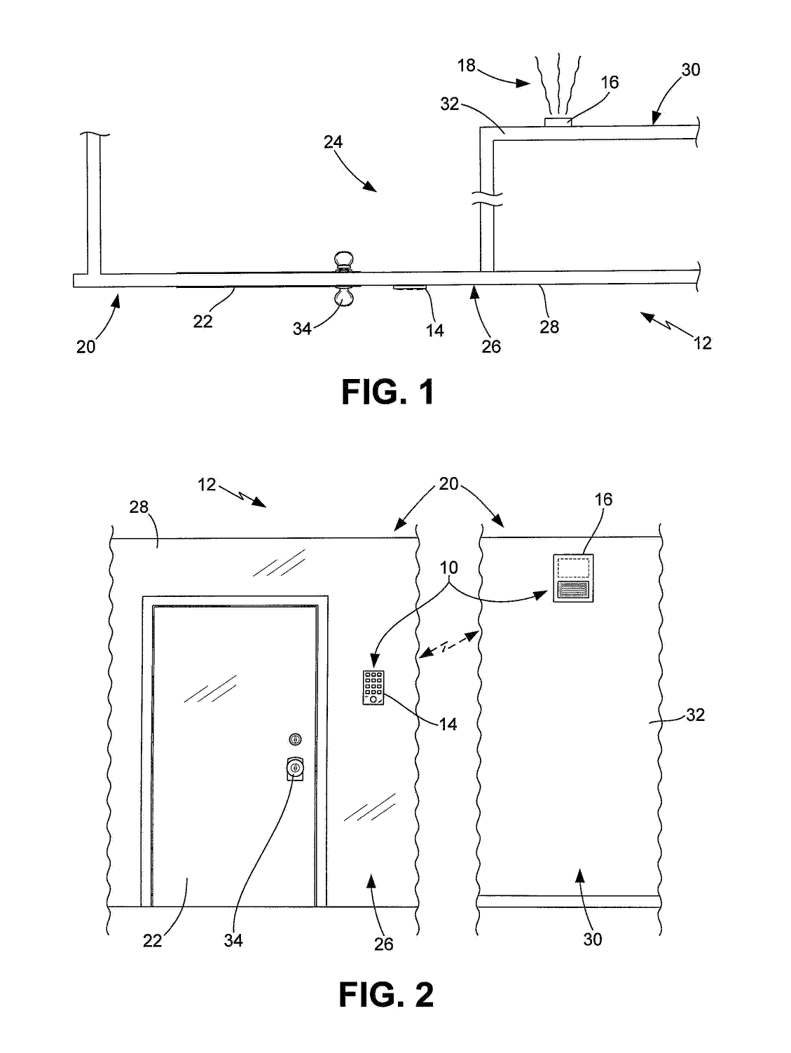

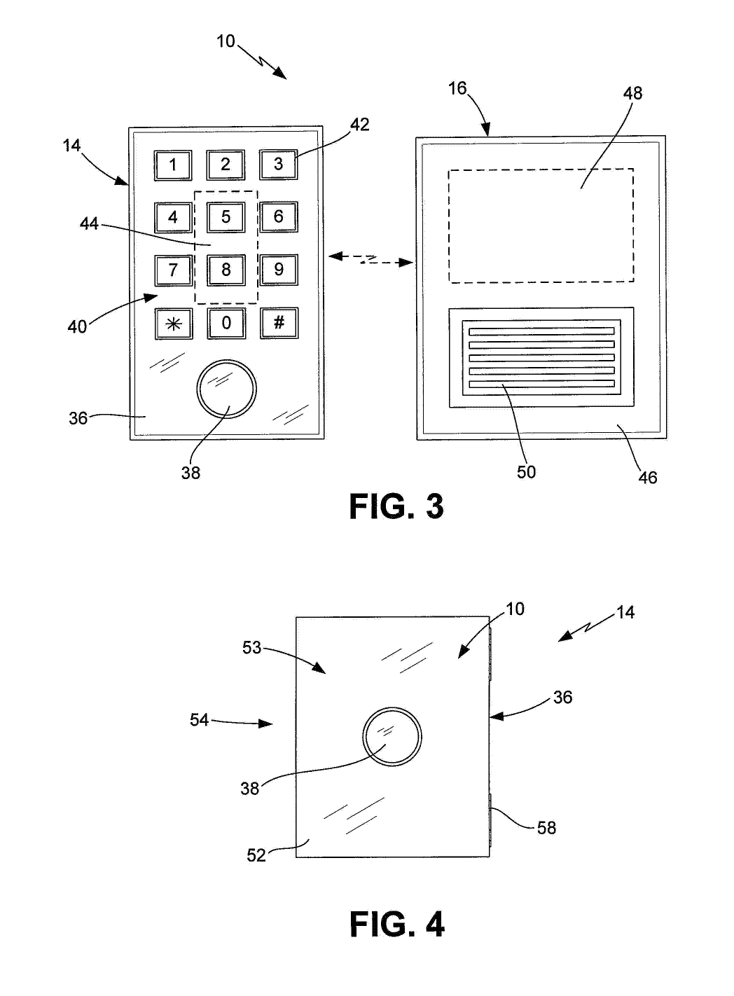

A coded doorbell chime that comprises the components and which is configured pursuant to various embodiments of the present invention is shown generally as 10 in FIGS. 2 and 3. A doorbell system utilizing the coded doorbell chime 10 of the present invention is shown generally as 12 in FIGS. 1 and 2. As shown in the figures and explained in more detail below, the coded doorbell chime 10 generally comprises a doorbell activating device 14 and a sound producing mechanism 16 that produces a sound, shown as 18 in FIG. 1, in response to operation of doorbell activating device 14. As is common for prior art doorbells and doorbell systems, the coded doorbell chime 10 and system 12 of the present invention will usually, but not necessarily exclusively, be utilized with a structure 20 having a door 22 that opens to an interior 24 of the structure 20, as best shown in FIG. 1. Typically, the doorbell activating device 14 will be attached to or otherwise mounted on an outwardly facing surface 26 of an outer wall 28 of the structure 20 and the sound producing mechanism 16 will be attached to or otherwise mounted on an inwardly facing surface 30 of an inner wall 32 inside the interior 24 of the structure 20, as shown in FIGS. 1 and 2. In most installations of the coded doorbell chime 10 and system 12, the doorbell activating device 14 will be positioned on surface 26 at or near the door 22, typically within arm's reach of the doorknob 34 of door 22, such that a person who is standing at the door 22 wanting to talk to the occupant of the structure 20 and/or enter into the interior 24 of the structure 20 can easily reach and operate the doorbell activating device 14 from in front of the door 22. The sound producing mechanism 16 will typically be positioned in the interior 24 of structure 20 so the sound 18 produced therefrom can be heard, at least generally, throughout the interior 24. As will be readily appreciated by those skilled in the art, although the coded doorbell chime 10 and system 12 of the present invention may be most commonly utilized with a house, apartment or other living quarters as the structure 20, such as presently available doorbells and doorbell systems are often utilized, the coded doorbell chime 10 and system 12 of the present invention can be utilized with a wide variety of different structures 20, including but not limited to offices, stores, warehouses and the like, where the occupant of structure 20 may desire to selectively control the sound produced by the sound producing mechanism 16 based on the category or similar information about the visitor to the structure.

The doorbell activating device 14 of the present invention is arranged and structured to allow a person at the door 22 to activate the sound producing mechanism 16 so as to produce a sound 18 therefrom. As shown in FIGS. 3 through 6, the doorbell activating device 14 has a first housing 36 enclosing the various electronic components of the device 14 and which supports the activating apparatuses, such as the switch 38 and keypad 40, that are selectively accessed by the person at the door 22. The first housing 36 is structured and arranged to be attached to or mounted on outwardly facing surface 26, typically having one or more openings through which screws, bolts or other connectors are inserted into the surface 26. The switch 38 of FIGS. 3 through 6 is a standard, commonly utilized push-button type of doorbell switch that is pushed by a visitor to produce a sound 18 from the sound producing mechanism 16. As well known, the switch 38 has an electrical circuit that is operatively connected to the sound producing mechanism 16 such that pressure on the switch 38 closes the circuit and produces the sound 18. The switch 38 may be connected by one or more wires to the sound producing mechanism 16 or it may be wirelessly connected utilizing an appropriately configured transmitter in or otherwise associated with the housing 36 and a cooperatively configured receiver associated with the sound producing mechanism 16. In general, the configuration and operation of switches 38, whether of the push-button type or other types, are well known in the art. In the embodiment of FIG. 3, both the switch 38 and keypad 40 are on an outwardly facing surface of housing 36. In the embodiments of FIGS. 4 through 6, which as set forth in more detail below are generally preferred embodiments of the present invention, only the switch 38 is on the outwardly facing surface of housing 36.

As best shown in FIGS. 3, 5 and 6, the keypad 40 comprises a plurality of keys 42 that, typically, are separately numbered and connected to an appropriately configured processor, shown as 44 in FIG. 3, such that a person can enter a pre-selected numerical code via the keys 42 of keypad 40 that is recognized by the processor 44 to produce a desired sound 18 by the sound producing mechanism 16. If the person at the door 22 enters an incorrect code or utilizes the standard push-button (or other type) switch 38, then a different sound 18 will be produced by sound producing mechanism 16. In this manner, the occupant of the structure 20 will know, at least generally, the identity of the visitor at the door 22 by the sound 18 which is generated by the sound producing mechanism 16 in response to either the entry of the correct code at keypad 40 or the incorrect code or activation of switch 38. As such, different people or different categories of people (e.g., family, friends, workers and etc.) can be provided with the code, or different codes, that allows them to produce one or more sounds 18 while other visitors will have to access the switch 38 to produce a different sound 18 from the sound producing mechanism 16.

As best shown in FIGS. 2 and 3, the sound producing mechanism 16 generally comprises a second housing 46 enclosing a sound generator 48 and a speaker 50 that is connected to the sound generator 48 to produce the sound 18 that is heard in the interior 24 of the structure 20. The second housing 46 is structured and arranged to be attached to or mounted on inwardly facing surface 30, typically having one or more openings through which screws, bolts or other connectors are inserted into the surface 30. The structure and arrangement of sound producing mechanisms 16 are generally well known in the art. With regard to the present invention, however, the sound generator 48 is selected so as to produce two or more sounds 18, preferably sufficiently distinct that the occupant of the structure 20 can easily distinguish the sounds 18 from each other so that he or she can readily determine whether the visitor at the door 22 entered the correct code on keypad 40 or if the visitor utilized switch 38 and/or entered an incorrect code at keypad 40. The sound generator 48 of the sound producing mechanism 16 is operatively connected to the doorbell activating device 14 such that operation thereof by activation of the switch 38 or entry of the correct code at keypad 40 will cause the sound generator 48 to produce a selected sound 18 through the speaker 50. As will be readily appreciated by those skilled in the art, the doorbell activating device 14 and the sound producing mechanism 16 may be connected by one or more wires (wired connection) or these two components may be wirelessly connected. In the latter type of connection, the housing 36 of the doorbell activating device 14 will typically, but not necessarily exclusively, enclose a wireless transmitter that directs a wireless signal to an appropriately configured receiver that is associated with the sound producing mechanism 16, typically enclosed in the housing 46 thereof.

In a preferred embodiment, the processor 44 in the housing 36 of the doorbell activating device 14 will be suitable for multiple codes via keypad 40 and the sound generator 48 of the sound producing mechanism 16 will be configured to produce a number of different sounds 18, in response to the entry of the codes at keypad 40, so that the user of the coded doorbell chime 10 and system 12 of the present invention can provide the desired visitors with different codes to produce different sounds. In this manner, the user can provide one visitor, or category of visitors, with one code that produces a certain sound 18 and provide other visitors, or categories of visitors, with different codes that produce different sounds 18. With the different codes held by different visitors and/or categories of visitors, the occupant of the structure 20 can very quickly and easily determine who is at the door 22, or at least which category of visitors he or she is associated. Based on the sound 18 from the sound generator 48 of the sound producing mechanism 16, the occupant of the structure 20 can make a decision with regard to the visitor at the door 22 without having to actually open the door or even look out a porthole or nearby window, at which point it is often too late and/or awkward to ignore the visitor at the door 22.

In a typical installation of the coded doorbell chime 10 and system 12 of the present invention, both the doorbell activating device 14 and the sound producing mechanism 16 will be connected to the electrical wiring system of the structure 20 to provide the power necessary to operate the components thereof, including the processor 44, sound generator 48, speaker 50 and, if utilized, any wireless communication devices. As will be readily apparent to those skilled in the art, one or both the doorbell activating device 14 and the sound producing mechanism 16 can be battery-powered instead of being connected to the wiring system of the structure 20. Typically, one or more batteries (as appropriate) will be enclosed in either or both the housing 36 of the doorbell activating device 14 and/or the housing 46 of the sound producing mechanism 16.

As shown with regard to FIGS. 2 and 3 and described above, both the push-button switch 38 and the keypad 40 can be positioned on an outwardly facing surface of the housing 36 of the doorbell activating device 14. With this configuration, a visitor approaching the door 22 will see both the switch 38 and the keypad 40 and will, typically, utilize the switch 38 (because they know they do not have a code) to activate the sound generator 48 of the sound producing mechanism 16 to produce a particular sound 18 that informs the occupant of the structure 20 that an “unauthorized” visitor is at the door 22. With the keypad 40 exposed, the visitor may attempt to use the keys 42 to enter a code. If they do not know the correct code, the “default” sound 18 will be produced, typically the same sound 18 as when using switch 38, thereby informing the occupant of structure 20 that an “unauthorized” visitor is at the door 22.

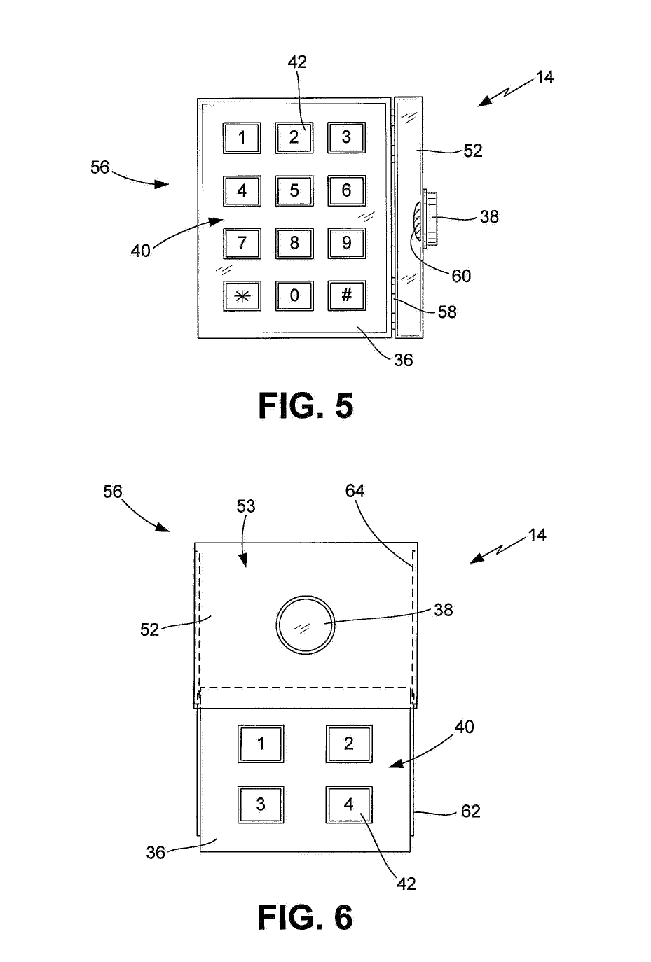

In a preferred configuration of the coded doorbell chime 10 and the system 12 of the present invention, the doorbell activating device 14 is configured with an openable cover 52 that covers the keypad 40, as shown with regard to the embodiments of FIGS. 4 through 6, with the doorbell switch 38 on the outer surface 53 of the cover 52. In these embodiments, the housing 36 and the cover 52 of the device 14 are cooperatively configured such that the device 14 can be easily moved between its closed position 54 closing off access to the keypad 40, as shown in FIG. 4, and its opened position 56 that allows access to the keypad 40, as shown in FIGS. 5 and 6. Preferably, the cover 52 is moveably connected to the housing 36 so the keypad 40 can be exposed without removing the cover 52 from the housing 36. Various openable attachment mechanisms are well known in the art. For example, in the embodiment of FIGS. 4 and 5, cover 52 is pivotally attached to the housing 36 by one or more hinge elements 58 to allow the visitor to move the device 14 from its closed position 54 to its opened position 56 by swinging open the cover 52 so he or she may enter the appropriate code using the keys 42 of keypad 40. If desired, a thumb grip 60 can provided on the cover 52, as shown in FIG. 5, to allow the visitor to place his or her thumb or other finger thereon to facilitate easy opening of the cover 52. The configuration and use of such thumb grips 60 are well known in the art.

The embodiment of FIG. 6 shows an alternative embodiment for movably associating the cover 52 with the housing 36 of the doorbell activating device 14 to allow easy access to the keypad 40. In this embodiment, the cover 52 is slidably connected to the housing 36. As well known in the art, a variety of different configurations of slidable connections can be utilized to slidably connect the cover 52 to the housing 36. In the example embodiment shown in FIG. 6, the housing 36 is provided with a pair of spaced apart rails 62, typically at or near the sides of the housing that are sized and configured to be received in appropriately positioned and configured grooves 64 in the cover 52, typically in the underside surface thereof (as shown in FIG. 6). In this embodiment, the cover 52 and the housing 36 are configured such that the cover 52 will slide upward to move the device 14 to its opened position 56 exposing and allowing access to the keypad 40 and slide back down to cover the keypad 40 and place the device 14 back into its closed position 54 (as shown in the embodiment of FIG. 4).

As best shown in FIG. 4, when the doorbell activating device 14 is in its closed position 54 with the cover 52 over the keypad 40, the device 14 will appear as a typical prior art doorbell having the push-button (or other type) switch 38, albeit maybe slightly larger size, on the outer surface 53 of the cover 52. Any visitors who does not know of the coded doorbell chime 10 and system 12 of the present invention will assume the doorbell activating device 14 is a standard doorbell and will push or otherwise activate the switch 38, which will cause the sound producing mechanism 16 to produce a sound 18 that is not associated with a known or desired visitor, namely one who enters a correct code using the keys 42 of the keypad 40. Even if the “unknown” visitor does figure out that he or she can move the cover 52 relative to housing 36, they will not know a proper code and, as such, will enter in an improper code at keypad 40, causing the sound producing mechanism 16 to produce the sound 18 that the occupant associates with unknown visitors.

A variety of different types of keypads 40 and/or processors 44 can be utilized with the doorbell activating device 14 of the present invention. For instance, the embodiments of FIGS. 3 and 5 show the use of a standard or typical keypad 40 having twelve keys 42, one for each number 0-9 and one each for an “*” and “#” symbol, whereas the embodiment of FIG. 6 shows the use of a keypad 40 having only four keys 42. As will be readily appreciated by those skilled in the art, as long as there is more than one key 42, keypad 40 can have any number of keys 42. Likewise, the symbols on the keys 42 can be numeric, as shown and will generally be preferred, or they can be letters or other symbols. In addition, the processor 44 can be configured to accept one or more different codes. In a preferred configuration, the doorbell activating device 14 is configured to allow the user thereof to enter in and store a plurality of different codes in the processor 44 so that a plurality of different “known” visitors, or categories of visitors, can be provided with different codes so as to produce different sounds 18 from the sound producing mechanism 16. In such an embodiment, the sound generator 48 of the sound producing mechanism 16 should be configured to produce a plurality of different “known” visitor sounds 18, in response to proper codes being entered, in addition to the “unknown” visitor sound 18 if the switch 38 is operated and/or an improper code is entered. As will be readily appreciated by those skilled in the art, such a configuration will make it easier for the occupant to make the decision to answer or ignore the visitor.

In use, the doorbell activating device 14 will be attached or mounted to a surface, such as the outwardly facing surface 26 of outer wall 28, where it will be accessible to visitors of the structure 20 having the coded doorbell chime 10 and system 12 of the present invention. Typically, doorbell activating device 14 will be placed near a door 22 that allows access, when opened, into the interior 24 of the structure 20. The sound producing mechanism 16 will be attached to or otherwise mounted on a surface, such as the inwardly facing surface 30 of an interior wall 32 in the interior 24 of structure 20, where the sound 18 produced by the sound generator 48 and broadcast by speaker 50 can be heard sufficiently throughout the interior 24 of the structure 20 to be useful to an occupant in the structure 20. The user will program one or more codes into the processor 44, typically using the keys 42 of keypad 40, and associate the codes with one or more different sounds, which will be selected (often by the user, but sometimes pre-programmed into the mechanism 16) and provide the code to one or more visitors whom the occupant will want to approach the door 22 if he or she hears the sound 18 that is associated with that visitor(s). Preferably, the processor 44 will be selected so as to allow the user of the coded doorbell chime 10 and system 12 of the present invention to modify, cancel and/or add new codes as he or she may deem necessary or beneficial. When the doorbell activating device 14 activates the sound producing mechanism 16, the occupant of the structure 20 will immediately be able to determine whether the visitor who is at the door 22 is a person he or she wants to speak to or whether he or she would rather ignore and, therefore, not approach the door 22.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A coded doorbell chime, comprising:
a doorbell activating device having a first housing structured and arranged to be attached to or mounted on a first surface, a doorbell switch on or otherwise associated with said first housing, a keypad on said first housing and a processor disposed in said first housing, said keypad having a plurality of keys, said processor operatively connected to said keypad to allow entry of a code into said processor using said keypad; and
a sound producing mechanism having a second housing structured and arranged to be attached to or mounted on a second surface, a sound generator disposed in said second housing and a speaker associated with said second housing and connected to said sound generator, said sound generator operatively connected to said doorbell activating device so as to produce a first sound through said speaker when said code is entered into said processor and a second sound through said speaker when said doorbell switch is operated.

2. The coded doorbell chime of claim 1, wherein said first surface is on an outer wall of a structure and disposed so as to be outwardly facing therefrom.

3. The coded doorbell chime of claim 2, wherein said doorbell activating device is positioned at or near a door allowing access to an interior of said structure.

4. The coded doorbell chime of claim 3, wherein said second surface is on an interior wall in said interior of said structure and disposed so as to be inwardly facing therefrom, said sound producing mechanism positioned on said second surface so as to discharge said first sound and said second sound through said speaker into said interior of said structure.

5. The coded doorbell chime of claim 1, wherein said second surface is on an interior wall in an interior of a structure and disposed so as to be inwardly facing therefrom, said sound producing mechanism positioned on said second surface so as to discharge said first sound and said second sound through said speaker into said interior of said structure.

6. The coded doorbell chime of claim 1, wherein said doorbell activating device comprises a cover moveably attached to said first housing, said cover structured and arranged to cover over said keypad when said doorbell activating device is in a closed position and to expose said keypad when said doorbell activating device is in an opened position.

7. The coded doorbell chime of claim 6, wherein said cover is pivotally attached to said first housing.

8. The coded doorbell chime of claim 7 further comprising one or more hinge elements interconnecting said first housing and said cover of said doorbell activating device.

9. The coded doorbell chime of claim 6, wherein said cover is slidably attached to said first housing.

10. The coded doorbell chime of claim 9 further comprising one or more rails on said first housing and one or more grooves on said cover, said rails and said grooves cooperatively configured and positioned so said rails are received in said grooves to allow said cover to slide relative to said first housing.

11. The coded doorbell chime of claim 6, wherein said doorbell switch is on an outer surface of said cover so as to be facing outwardly therefrom when said doorbell activating device is in said closed position with said cover over said keypad.

12. A coded doorbell chime, comprising:
a doorbell activating device having a first housing structured and arranged to be attached to or mounted on an outwardly facing surface of an outer wall of a structure, a keypad on said first housing and a processor disposed in said first housing, said keypad having a plurality of keys, said processor operatively connected to said keypad to allow entry of a code into said processor using said keypad;
a cover moveably attached to said first housing, said cover structured and arranged to cover said keypad when said doorbell activating device is in a closed position and to expose said keypad when said doorbell activating device is in an opened position;
a doorbell switch on an outer surface of said cover so as to be facing outwardly therefrom when said doorbell activating device is in said closed position with said cover over said keypad; and
a sound producing mechanism having a second housing structured and arranged to be attached to or mounted on an inwardly facing surface of an inner wall of said structure, a sound generator disposed in said second housing and a speaker associated with said second housing and connected to said sound generator, said sound generator operatively connected to said doorbell activating device so as to produce a first sound through said speaker when said code is entered into said processor and a second sound through said speaker when said doorbell switch is operated.

13. The coded doorbell chime of claim 12, wherein said cover is pivotally attached to said first housing.

14. The coded doorbell chime of claim 13 further comprising one or more hinge elements interconnecting said first housing and said cover of said doorbell activating device.

15. The coded doorbell chime of claim 12, wherein said cover is slidably attached to said first housing.

16. The coded doorbell chime of claim 15 further comprising one or more rails on said first housing and one or more grooves on said cover, said rails and said grooves cooperatively configured and positioned so said rails are received in said grooves to allow said cover to slide relative to said first housing.

17. A doorbell system, comprising:
a structure having an outer wall with an outwardly facing surface and an inner wall in an interior of said structure, said inner wall having an inwardly facing surface thereon;
a door associated with said outer wall of said structure;
a doorbell activating device having a first housing, a keypad on said first housing and a processor disposed in said first housing, said first housing structured and arranged to be attached to or mounted on said outwardly facing surface of said outer wall at or near said door, said keypad having a plurality of keys, said processor operatively connected to said keypad to allow entry of a code into said processor using said keypad;
a doorbell switch associated with said first housing; and
a sound producing mechanism having a second housing, a sound generator disposed in said second housing and a speaker associated with said second housing and connected to said sound generator, said second housing structured and arranged to be attached to or mounted on said inwardly facing surface of said inner wall, said sound generator operatively connected to said doorbell activating device so as to produce a first sound through said speaker when said code is entered into said processor and a second sound through said speaker when said doorbell switch is operated.

18. The doorbell system of claim 17, wherein said doorbell activating device comprises a cover moveably attached to said first housing, said cover structured and arranged to cover over said keypad when said doorbell activating device is in a closed position and to expose said keypad when said doorbell activating device is in an opened position.

19. The doorbell system of claim 18, wherein said doorbell switch is on an outer surface of said cover and disposed so as to be facing outwardly therefrom when said doorbell activating device is in said closed position with said cover over said keypad.

20. The doorbell system of claim 19, wherein said cover is pivotally or slidably attached to said first housing.
